(19) United States
(12) Patent Application Publication
(10) Pub. No.: US 2019/0212716 A1
(43) Pub. Date: Jul. 11, 2019

(54) THREE-DIMENSIONAL PRINTER AND SCANNING MODULE THEREOF

(71) Applicants: XYZPRINTING, INC., New Taipei City (TW); KINPO ELECTRONICS, INC., New Taipei City (TW)

(72) Inventors: Yang-Teh LEE, NEW TAIPEI CITY (TW); Jia-Yi JUANG, NEW TAIPEI CITY (TW); Chun-Hsiang HUANG, NEW TAIPEI CITY (TW); Yi-Chu HSIEH, NEW TAIPEI CITY (TW); Ming-En HO, NEW TAIPEI CITY (TW)

(21) Appl. No.: 15/951,139

(22) Filed: Apr. 11, 2018

(30) Foreign Application Priority Data
Jan. 8, 2018 (CN) 201810015793.2

(51) Int. Cl. G05B 19/4099; B29C 67/00; B29C 64/153; B29C 64/393; B29C 64/35

(52) U.S. Cl. CPC G05B 19/4099; B29C 67/0007; B29C 64/153; B33Y 10/00; B29C 64/35; G05B 2219/49023; G05B 2219/35063; B29C 64/393

(57) ABSTRACT

A three-dimensional printer and a scanning module thereof is provided. The three-dimensional printer includes a case, a printing platform, a cleaning module, a three-dimensional printing module, a coloring nozzle module and a scanning module. A containing chamber is defined in the case, and a first area and a second area are defined in the containing chamber. The printing platform is arranged in the first area. A portion of the second area is occupied by the cleaning module, and a remaining space is formed by the second area. The three-dimensional printing module and the coloring nozzle module are arranged over the printing platform. The cleaning module is used to clean the coloring nozzle module. The scanning module is arranged in the remaining space. A user obtains a three-dimensional model information of a scanned object via the scanning module, and the three-dimensional printer therefore gains more popularity.

### BACKGROUND OF THE INVENTION

### 1. Technical Field

The technical field relates to a printer structure, and in particular, to a three-dimensional printer and a scanning module thereof.

### 2. Description of Related Art

Three-dimensional (3D) printing is one of quick formation techniques. As a movable platform moves a work carrier, metal powders or plastic powders are deposited layer by layer and fused together to build up a 3D object by additive manufacturing techniques. Toy parts, mechanical parts or artificial human bones can be made by 3D printing, so 3D printing is growing rapidly in popularity with the consuming public.

However, in order to carry out 3D printing, a drawing software like a computer-aided design software is used to build a model first, and then the 3D model is sliced into layers of cross-sections. Finally, a 3D printer prints out an object according to the information of the cross-sections. Hence, a user has to learn a drawing software first before operating the 3D printer. As a result, popularity of the 3D printers is difficult to grow rapidly.

In view of this, the inventor studied various technologies and created an effective solution in the present disclosure.

### SUMMARY OF THE INVENTION

The present disclosure provides a three-dimensional (3D) printer and a scanning module thereof. The scanning module is installed in a remaining space inside a case. A user can use the scanning module to acquire a three-dimensional model information for a scanned object. Then, according to the three-dimensional model information, the three-dimensional printer prints out a three-dimensional object just like the scanned object. Therefore, users do not need to learn a drawing software like a computer-aided design software before operating the three-dimensional printer. Hence, the three-dimensional printer can gain popularity more easily.

The present embodiment provides a three-dimensional (3D) printer, comprising: a case, a containing chamber being disposed inside the case, the containing chamber being divided into a first area and a second area; a printing platform disposed in the first area; a cleaning module disposed in a portion of the second area, the remaining portion of the second area forming a remaining space; a three-dimensional printing module arranged over the printing platform; a coloring nozzle module, the coloring nozzle module being arranged over the printing platform and movable to the cleaning module, the cleaning module being used to clean the coloring nozzle module; and a scanning module installed in the remaining space.

One embodiment of the present disclosures provides a scanning module of a three-dimensional printer, the three-dimensional printer including a bottom base, the bottom base including a first electrical connector, the scanning module comprising: an image capture device detachably connected to the bottom base, the image capture device including a second connector, the second connector being electrically connected to the first electrical connector; and a rotary plate detachably connected to the bottom base, the image capture device being disposed corresponding to the rotary plate.

To sum up, the cleaning module is installed inside the case. In order to prevent the printing platform from colliding with the cleaning module during ascending and descending movement of the printing platform, the printing platform and the cleaning module are staggered. Since the cleaning module is much smaller than the printing platform, the remaining space is formed at one side and under the cleaning module. The scanning module is installed in the remaining space inside the case, so that a scanning feature is added to the three-dimensional printer without the need of increasing the size of the three-dimensional printer, and the space inside the three-dimensional printer is used effectively.

### BRIEF DESCRIPTION OF THE DRAWINGS

The disclosure will become more fully understood from the detailed description and the drawings given herein below for illustration only, and thus does not limit the disclosure, wherein:

FIG. 1 is a perspective assembled view illustrating a three-dimensional printer of the present disclosure;

FIG. 2 is a perspective exploded view illustrating the three-dimensional printer of the present disclosure;

FIG. 3 is a perspective view illustrating a scanning module of the present disclosure;

FIG. 4 is a front view illustrating the three-dimensional printer;

FIG. 5 is a top view illustrating the three-dimensional printer;

FIG. 6 is a schematic in-use view illustrating the three-dimensional printer;

FIG. 7 is another in-use view illustrating the three-dimensional printer;

FIG. 8 is a cross-sectional view illustrating the three-dimensional printer; and

FIG. 9 is a cross-sectional view taken along line 9-9 of FIG. 8.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

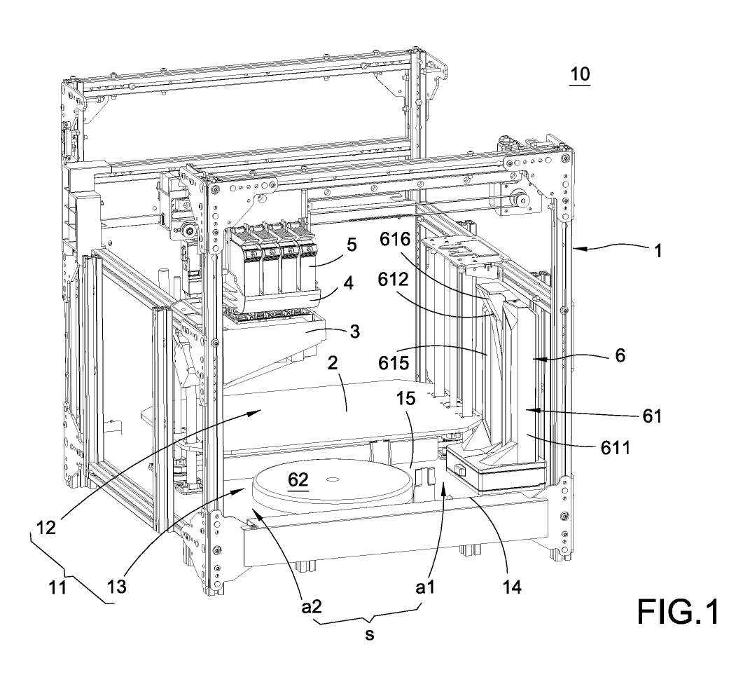

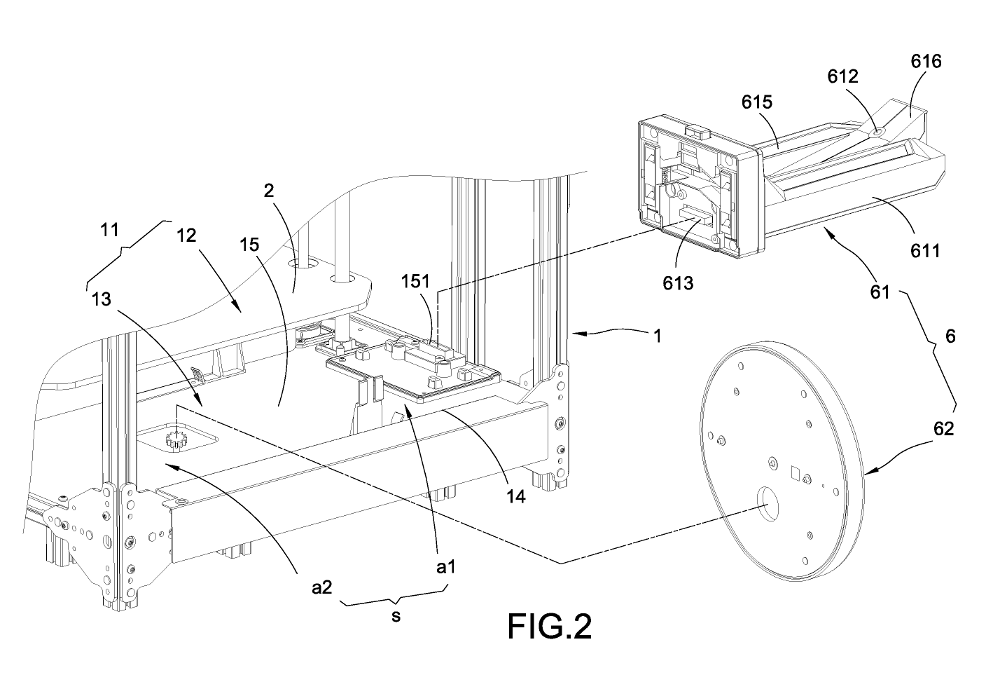

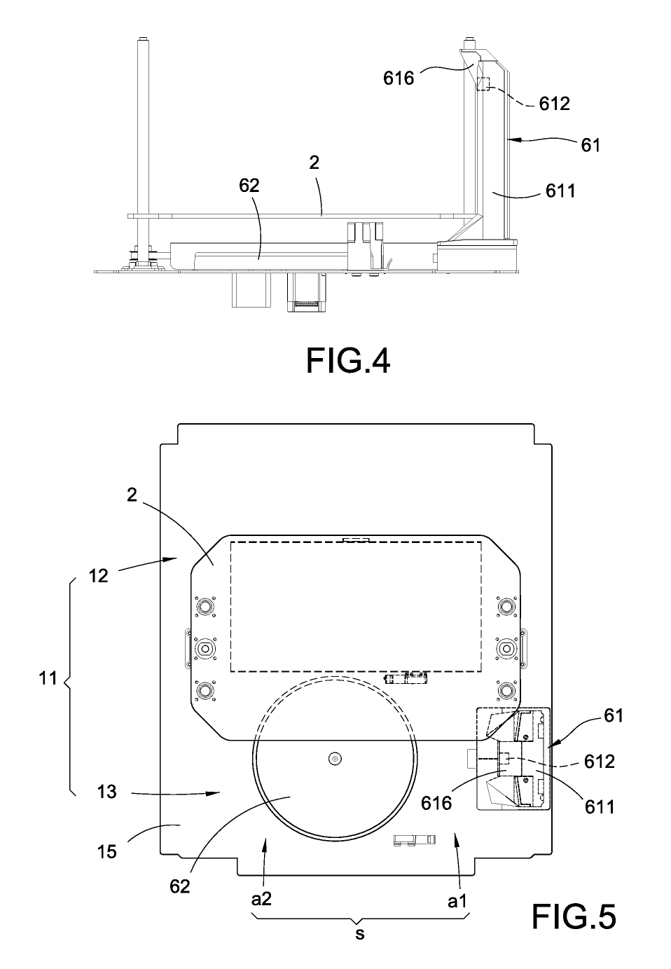

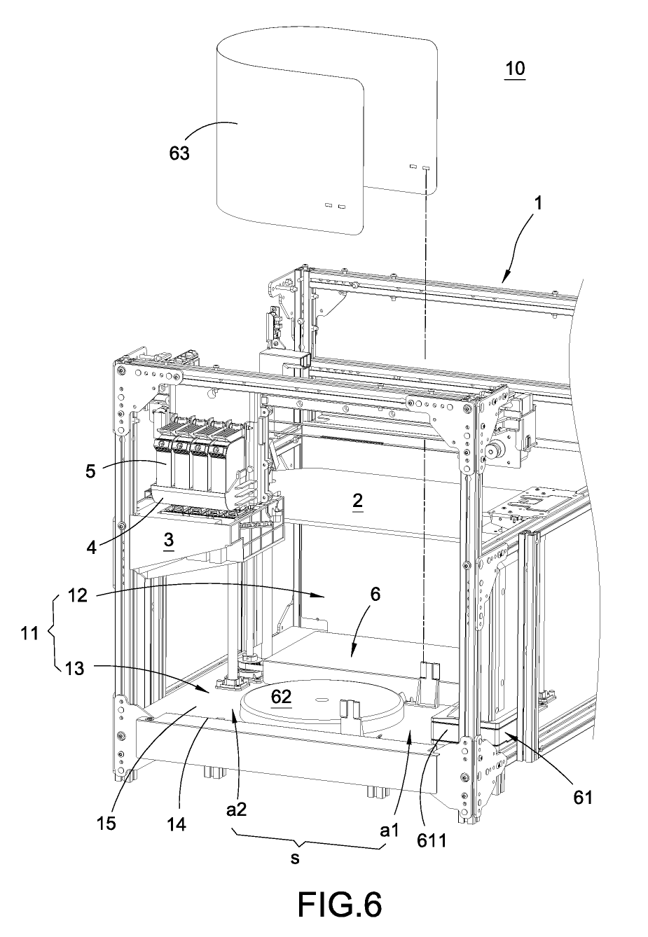

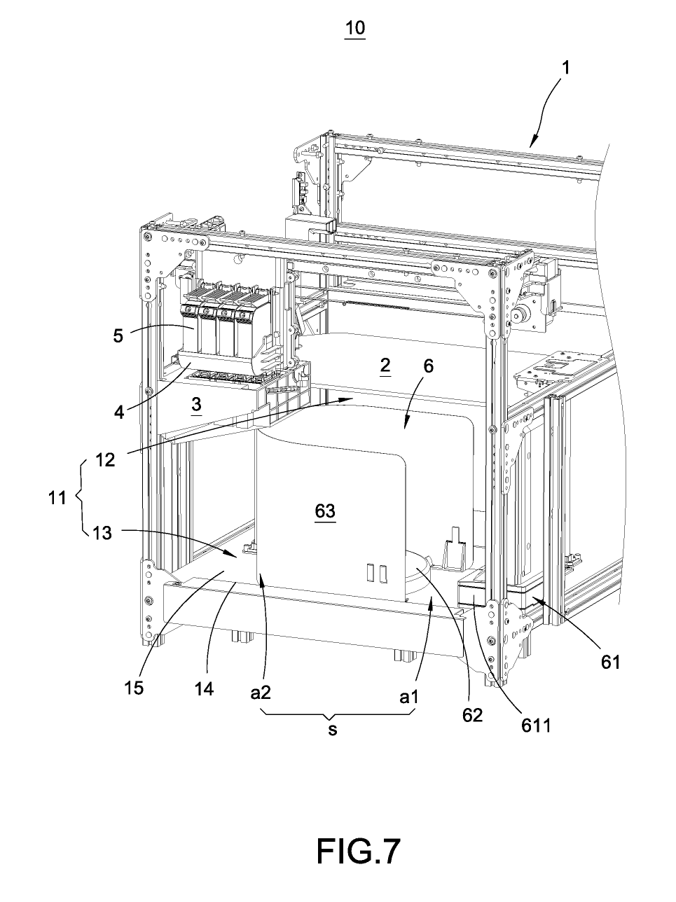

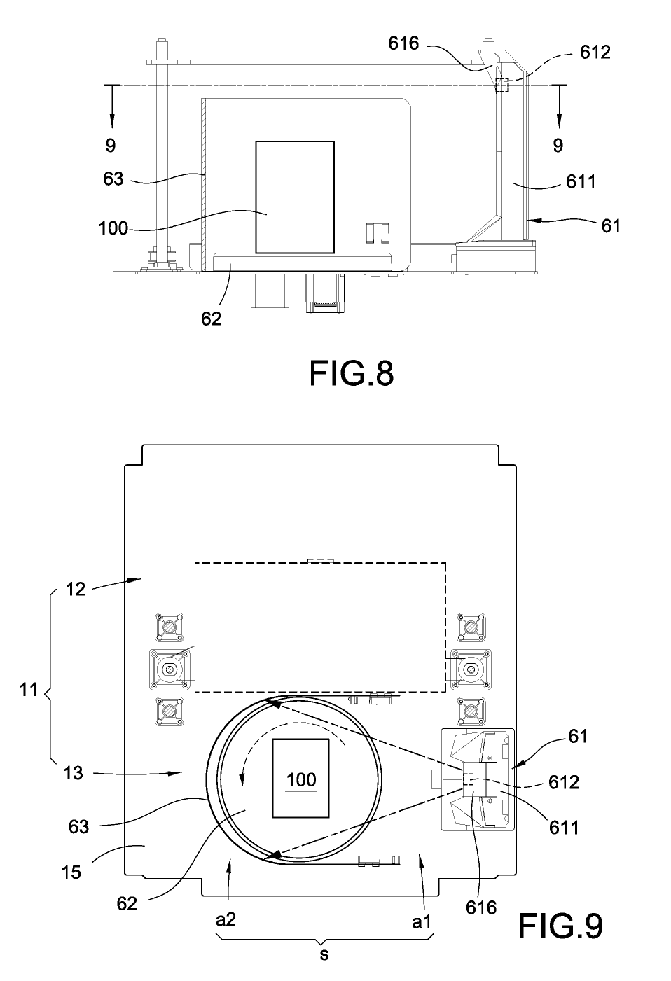

Referring to FIGS. 1 to 9, the present disclosure provides a three-dimensional (3D) printer and a scanning module thereof. The three-dimensional printer 10 includes a case 1, a printing platform 2, a cleaning module 3, a three-dimensional printing module 4, a coloring nozzle module 5, and a scanning module 6. The scanning module 6 includes an image capture device 61 and a rotary plate 62.

As shown in FIGS. 1, 6 and 7, a containing chamber 11 is disposed inside the case 1, the containing chamber 11 is divided into a first area 12 and a second area 13. The case 1 includes an opening 14 communicating with the containing chamber 11 and includes a bottom base 15 disposed at the bottom of the containing chamber 11. The bottom base 15 includes a first electrical connector 151.

As shown in FIGS. 1, 6 and 7, the printing platform 2 is usually a rectangular platform or a round platform, so a large rectangular space is needed for ascending or descending of the printing platform 2. In order to prevent the printing platform 2 from colliding with the cleaning module 3 during ascending or descending movement of the printing platform 2, the platform 2 and the cleaning module 3 are staggered and not overlapped. The cleaning module 3 occupies a much smaller space than the printing platform 2, so the printing platform 2 is installed in the first area 12, and the cleaning module 3 is installed in a portion of the second area 13. The remaining portion of the second area 13 forms a remaining space s. The remaining space s is divided into a first idle space al opposite to the cleaning module 3 and a second idle space a2 under the cleaning module 3.

The printing platform 2 in the first area 12 can be secured in a movable or fixed manner. The cleaning module 3 in the second area 13 can also be secured in a movable or fixed manner. The first area 12 is away from the opening 14 of the case 1, and the second area 13 is disposed adjacent to the opening 14 of the case 1. Since the cleaning module 3 often needs to be replaced or cleaned, the cleaning module 3 is disposed near the opening 14 to facilitate detachment and attachment of the cleaning module 3.

As shown in FIGS. 1, 6 and 7, the three-dimensional printing module 4 is installed over the printing platform 2. The coloring nozzle module 5 is also arranged over the printing platform 2 and is movable to the cleaning module 3. The cleaning module 3 is used to clean the coloring nozzle module 5. The three-dimensional printing module 4 and the coloring nozzle module 5 are assembled to the same movable base (not illustrated) to move together; however, the present disclosure is not limited in this regard, so the three-dimensional printing module 4 and the coloring nozzle module 5 can also be assembled to different movable bases and move separately.

As shown in FIGS. 1 to 9, the scanning module 6 is installed in the remaining space s. The scanning module 6 includes an image capture device 61 and a rotary plate 62, the image capture device 61 is installed in the first idle space al, the rotary plate 62 is installed in the second idle space a2, and the image capture device 61 is disposed corresponding to the rotary plate 62. In detail, the image capture device 61 and the rotary plate 62 are detachably connected to the bottom base 15, the image capture device 61 includes a second connector 613, and the second connector 613 is electrically connected to the first electrical connector 151, so that the first electrical connector 151 can supply power to the image capture device 61.

The image capture device 61 includes a body 611 and includes one or multiple image processors 612 installed on the body 611, the second connector 613 is installed at the bottom of the body 611, and the image processor 612 is electrically connected to the second connector 613, so that the first electrical connector 151 can supply power to the image processor 612. The image processor 612 is a camera or a 3D scanner having a structured light generator.

The image capture device 61 further includes one or multiple light emitting assemblies 614, the light emitting assembly 614 is installed on the body 611 and disposed at one side of the image processor 612, and the light emitting assembly 614 is electrically connected to the second connector 613, so that the first electrical connector 151 can supply power to the light emitting assembly 614. In the present embodiment, the light emitting assembly 614 is a light-emitting-diode (LED) strip; however, the present disclosure is not limited in this regard.

The image capture device 61 further includes one or multiple light diffusion structures 615. The light diffusion structure 615 is installed on the body 611 and covers the light emitting assembly 614, and the light diffusion structure 615 is a matte board.

In the present embodiment, the three-dimensional printer 10 has two image processors 612, two light emitting assemblies 614 and two light diffusion structures 615. The body 611 includes, at its middle section, an inclined protruding block 616 gradually thickening towards a top thereof, the two image processors 612 are installed one above the other in spaced-apart relation to each other on the inclined protruding block 616, so that the two image processors 612 overlook the rotary plate 62. The body 611 includes two trenches 617 disposed at two sides of the inclined protruding block 616, the two light emitting assemblies 614 are disposed at the two trenches 617 respectively, and the two light diffusion structures 615 cover the two trenches 617 respectively.

The scanning module 6 further includes a back plate 63, the back plate 63 is detachably connected to the bottom base 15 and surrounds the rotary plate 62 at one side away from the image capture device 61, and the back plate 63 is a light reflecting board or a light absorbing board.

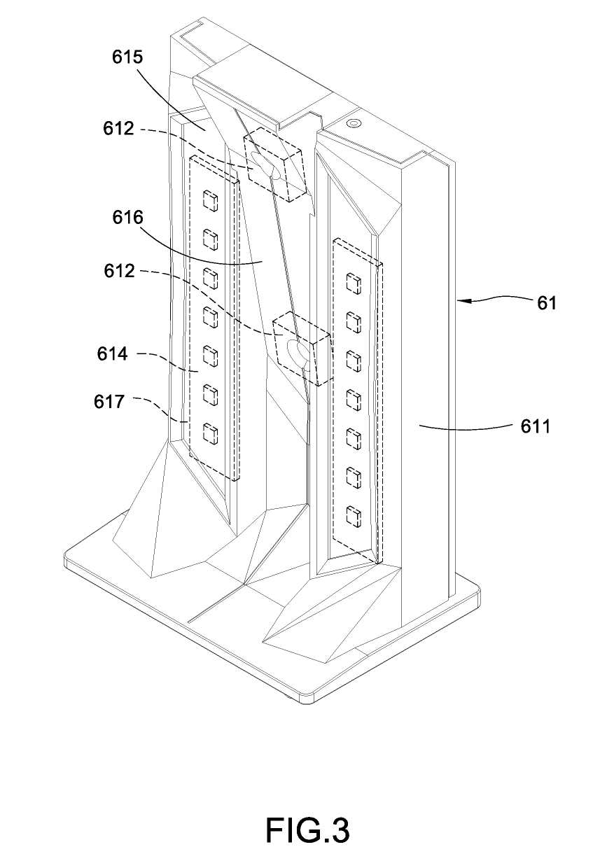

Please refer to FIGS. 3, 6 and 9 illustrating the three-dimensional printer 10 and the scanning module 6. The image capture device 61 is installed in the remaining space s inside the case 1. Then, the printing platform 2 is lifted, and the back plate 63 is installed in a space under the printing platform 2. The back plate 63 surrounds the rotary plate 62 at one side away from the image capture device 61. An object 100 to scan is placed on the rotary plate 62 and rotated by the rotary plate 62, so that the image processor 612 of the image capture device 61 can capture a three-dimensional model information of the scanned object 100 during its rotary movement.

Referring to FIGS. 1, 5 and 6, the back plate 63 is then removed to allow the printing platform 2 to ascend or descend. After that, the three-dimensional model information indicates the three-dimensional printing module 4 and the coloring nozzle module 5 to print out a three-dimensional object the same as the scanned object 100 by successively adding material layer by layer according to the three-dimensional model information, so that users can operate the three-dimensional printer 10 easily without the need of learning a drawing software like a computer-added design software in advance, and thus the three-dimensional printer 10 can gain more popularity.

As shown in FIG. 3 and FIGS. 7 to 9, the two image processors 612 are installed one above the other in spaced-apart relation to each other on the inclined protruding block 616, so that the two image processors 612 can overlook the object 100 to scan. The image capture device 61 further includes the light emitting assembly 614 and the light diffusion structure 615, so that the light generated from the light emitting assembly 614 can gently light up the object 100 to scan. When the back plate 63 is a light reflecting board, it concentrates light rays on the object 100 to scan. When the back plate 63 is a light absorbing board, it can absorb unwanted light rays on the object 100 to scan. Therefore, the image capture device 61 can correctly and clearly capture the three-dimensional model information.

As shown in FIGS. 1, 2, 4, 5, 6 to 9, the cleaning module 3 is installed inside the case 1. In order to prevent the printing platform 2 from colliding with the cleaning module 3 during ascending and descending movement of the printing platform 2, the printing platform 2 and the cleaning module 3 are staggered. Since the cleaning module 3 is much smaller than the printing platform 2, the remaining space s is formed at one side and under the cleaning module 3. The scanning module 6 is installed in the remaining space s inside the case 1, so that a scanning feature is added to the three-dimensional printer 10 without the need of increasing the size of the three-dimensional printer 10, and the space inside the three-dimensional printer 10 is used effectively.

In summary, the three-dimensional printer and the scanning module thereof are neither disclosed by similar products nor used in public, and has industrial applicability, novelty and non-obviousness, so the present disclosure completely meets the requirements of patentability. Therefore, a request to patent the present disclosure is filed according to patent laws. Examination is kindly requested, and allowance of the present disclosure is solicited to protect the rights of the inventor.

What is claimed is:

1. A three-dimensional printer, comprising:
a case, a containing chamber being disposed inside the case, the containing chamber being divided into a first area and a second area;
a printing platform disposed in the first area;
a cleaning module disposed in a portion of the second area, the remaining portion of the second area forming a remaining space;
a three-dimensional printing module arranged over the printing platform;
a coloring nozzle module, the coloring nozzle module being arranged over the printing platform and movable to the cleaning module, the cleaning module being used to clean the coloring nozzle module; and
a scanning module installed in the remaining space.

2. The three-dimensional printer according to claim 1, wherein the remaining space is divided into a first idle space opposite to the cleaning module and a second idle space under the cleaning module, the scanning module includes an image capture device and a rotary plate, the image capture device is installed in the first idle space, the rotary plate is installed in the second idle space, and the image capture device is disposed corresponding to the rotary plate.

3. The three-dimensional printer according to claim 2, wherein the case includes an opening communicating with the containing chamber, the first area is away from the opening, and the second area is disposed adjacent to the opening.

4. The three-dimensional printer according to claim 2, wherein the case includes a bottom base disposed at the bottom of the containing chamber, the image capture device and the rotary plate are detachably connected to the bottom base, the bottom base includes a first electrical connector, the image capture device includes a second connector, and the second connector is electrically connected to the first electrical connector.

5. The three-dimensional printer according to claim 4, wherein the image capture device includes a body and at least one image processor installed on the body, the second connector is installed at the bottom of the body, the image processor is electrically connected to the second connector, and the image processor is a camera or a three-dimensional scanner having a structured light generator.

6. The three-dimensional printer according to claim 5, wherein the image capture device further includes at least one light emitting assembly, the light emitting assembly is installed on the body and disposed at one side of the image processor, the light emitting assembly is electrically connected to the second connector, and the light emitting assembly is a light-emitting-diode strip.

7. The three-dimensional printer according to claim 6, wherein the image capture device further includes at least one light diffusion structure, the light diffusion structure is installed on the body and covers the light emitting assembly, and the light diffusion structure is a matte board.

8. The three-dimensional printer according to claim 7, wherein the three-dimensional printer includes two image processors, two light emitting assemblies and two light diffusion structures, the body includes, at its middle section, an inclined protruding block gradually thickening towards a top thereof, the two image processors are installed one above the other in spaced-apart relation to each other on the inclined protruding block, the body includes two trenches disposed at two sides of the inclined protruding block, the two light emitting assemblies are disposed at the two trenches respectively, and the two light diffusion structures cover the two trenches respectively.

9. The three-dimensional printer according to claim 4, wherein the scanning module further includes a back plate, the back plate is detachably connected to the bottom base and surrounds the rotary plate at one side away from the image capture device, and the back plate is a light reflecting board or a light absorbing board.

10. A scanning module of a three-dimensional printer, the three-dimensional printer including a bottom bas, the bottom base including a first electrical connector, the scanning module comprising:
an image capture device detachably connected to the bottom base, the image capture device including a second connector, the second connector being electrically connected to the first electrical connector; and
a rotary plate detachably connected to the bottom base, the image capture device being disposed corresponding to the rotary plate.

11. The scanning module of the three-dimensional printer according to claim 10, wherein the image capture device includes a body and at least one image processor installed on the body, the second connector is installed at the bottom of the base, the image processor is electrically connected to the second connector, and the image processor is a camera or a three-dimensional scanner having a structured light generator.

12. The scanning module of the three-dimensional printer according to claim 11, wherein the image capture device further includes at least one light emitting assembly, the light emitting assembly is installed on the body and disposed at one side of the image processor, the light emitting assembly is electrically connected to the second connector, and the light emitting assembly is a light-emitting-diode strip.

13. The scanning module of the three-dimensional printer according to claim 12, wherein the image capture device further includes at least one light diffusion structure, the light diffusion structure is installed on the body and covers the light emitting assembly, and the light diffusion structure is a matte board.

14. The scanning module of the three-dimensional printer according to claim 13, wherein the scanning module includes two image processors, two light emitting assemblies and two light diffusion structures, the body includes, at its middle section, an inclined protruding block gradually thickening towards a top thereof, the two image processors are installed one above the other in spaced-apart relation to each other on the inclined protruding block, the body includes two trenches disposed at two sides of the inclined protruding block, the two light emitting assemblies are disposed at the two trenches respectively, and the two light diffusion structures cover the two trenches respectively.

15. The scanning module of the three-dimensional printer according to claim 10, further comprising a back plate, the back plate being detachably connected to the bottom base and surrounding the rotary plate at one side away from the image capture device, and the back plate being a light reflecting board or a light absorbing board.
